(19) United States
(12) Patent Application Publication
(10) Pub. No.: US 2025/0162308 A1
(43) Pub. Date: May 22, 2025

(54) RECORDING ELEMENT SUBSTRATE AND RECORDING APPARATUS

(71) Applicant: CANON KABUSHIKI KAISHA, Tokyo (JP)

(72) Inventor: RYOHEI YAMADA, Kanagawa (JP)

(21) Appl. No.: 18/935,986

(22) Filed: Nov. 4, 2024

(30) Foreign Application Priority Data
Nov. 16, 2023 (JP) 2023-195108

(51) Int. Cl. B41J 2/045; B41J 2/14

(52) U.S. Cl. CPC B41J 2/0451; B41J 2/04538; B41J 2/04555; B41J 2/0458; B41J 2/14072; B41J 2/14112

(57) ABSTRACT

Provided is a recording element substrate, including: an ejection module including a heat generating resistive element; a current detection circuit including a current detection resistor connected in series between the heat generating resistive element and a voltage application terminal for applying voltage from a power supply to the heat generating resistive element, and a voltage detector for detecting a differential voltage at each end of the current detection resistor; an ejection circuit provided between the voltage application terminal and the heat generating resistive element, for applying voltage for causing the heat generating resistive element to generate heat from the voltage application terminal to the heat generating resistive element; and a control circuit for selecting any one of the current detection circuit and the ejection circuit.

### BACKGROUND OF THE INVENTION

### Field of the Invention

The present invention relates to a recording element substrate and a recording apparatus.

### Description of the Related Art

An inkjet recording head (recording head) for ejecting ink to form a desired image on a recording medium and an inkjet recording apparatus (recording apparatus) including the inkjet recording head have been known. In general, a recording element substrate to be mounted to the inkjet recording head has a heat generating resistive element for generating ink ejection energy. To form an image on a recording medium, an electric pulse is continuously applied to the heat generating resistive element such that ink is ejected. It is known that time-related deterioration due to the repeated ink ejection or due to the application of the electric pulse while there is no ink may cause change in resistance value of the heat generating resistive element and disconnection of electric wiring including the heat generating resistive element.

Meanwhile, in recent years, products and manufacturing methods that do not affect environments as little as possible have been sought after. By reusing and recycling used inkjet recording heads, resources can be effectively used to reduce environmental loads. In a step of regenerating a used head, a used head is collected from a house and the used head is first pre-checked in a recycling factory. As a result of the check, if there is abnormality in a heat generating resistive element inside a recording element substrate, the head is difficult to reuse, and is to be recycled.

In this case, if the above-mentioned pre-check of the recording head can be implemented not at a recycling factory but by a household inkjet recording apparatus, the pre-check can be implemented in a house before collecting a used head, and only a reusable recording head can be selected and delivered to a recycling factory. As a result, not all used heads are required to be collected, and cost for collection can be reduced.

Thus, in order to detect resistance value change or disconnection of a heat generating resistive element in a recording element substrate mounted to a recording head, a method in which detection wiring for detecting current flowing through the heat generating resistive element is formed inside the recording element substrate has been studied.

Japanese Patent Application Publication No. 2001-121703 discloses a configuration in which detection wiring is additionally provided so as to be adjacent to wiring of a heat generating resistive element in a recording element substrate. The wiring of the heat generating resistive element and the detection wiring are adjacent to each other, and hence there is parasitic capacitance between the wirings. Thus, if a wiring current value of the heat generating resistive element has changed, a voltage value of a resistor terminal that is ground-connected to the detection wiring changes through the parasitic capacitance due to electrostatic induction. In this method, the voltage value is compared with a threshold set in advance, and when a voltage value exceeding the threshold is detected, it is determined that the heat generating resistive element wiring has been disconnected.

### SUMMARY OF THE INVENTION

However, in Japanese Patent Application Publication No. 2001-121703, the heat generating resistive element wiring and the detection wiring are not directly connected, and hence the method is a current observation method by indirect electrostatic induction. Thus, a large change in current value flowing through the heat generating resistive element wiring can be ascertained, but detailed measurement of the current value cannot be performed. Accordingly, although the presence/absence of disconnection of the heat generating resistive element wiring can be detected, it is extremely difficult to detect detailed deterioration states caused by change in resistance value of the heat generating resistive element.

The present invention has been made in view of the above-mentioned problem. It is an object of the present invention to provide a technology for detecting detailed states of a heat generating resistive element provided in a recording element substrate for a recording head.

The present invention provides a recording element substrate, comprising:
an ejection module including a heat generating resistive element;
a current detection circuit including a current detection resistor connected in series between the heat generating resistive element and a voltage application terminal for applying voltage from a power supply to the heat generating resistive element, and a voltage detector configured to detect a differential voltage at each end of the current detection resistor;
an ejection circuit provided between the voltage application terminal and the heat generating resistive element, and configured to apply voltage for causing the heat generating resistive element to generate heat from the voltage application terminal to the heat generating resistive element; and a control circuit configured to select any one of the current detection circuit and the ejection circuit.

The present invention also provides a recording apparatus, comprising:
a recording element substrate; and
a determination unit,
wherein the recording element substrate includes:
   an ejection module including a heat generating resistive element;
   a current detection circuit including a current detection resistor connected in series between the heat generating resistive element and a voltage application terminal for applying voltage from a power supply to the heat generating resistive element, and a voltage detector configured to detect a differential voltage at each end of the current detection resistor;
   an ejection circuit provided between the voltage application terminal and the heat generating resistive element, and configured to apply voltage for causing the heat generating resistive element to generate heat from the voltage application terminal to the heat generating resistive element; and
   a control circuit configured to select any one of the current detection circuit and the ejection circuit, and
wherein the determination unit is configured to determine a state of the heat generating resistive element on the basis of output from the current detection circuit.

According to the present invention, the technology for detecting detailed states of a heat generating resistive element provided in a recording element substrate for a recording head can be provided.

Further features of the present invention will become apparent from the following description of exemplary embodiments with reference to the attached drawings.

### BRIEF DESCRIPTION OF THE DRAWINGS

FIG. 1 illustrates a circuit configuration corresponding to ejection ports in even-numbered rows in a recording element substrate according to a first embodiment;

FIG. 2 illustrates a circuit configuration corresponding to ejection ports in odd-numbered rows in the recording element substrate according to the first embodiment;

FIG. 3 illustrates a current detection circuit according to the first embodiment;

FIGS. 4A and 4B illustrate input/output signal waveforms according to the first embodiment;

FIG. 5 illustrates a circuit configuration and an inkjet recording apparatus according to the first embodiment;

FIG. 6 illustrates a current detection circuit according to a second embodiment;

FIG. 7 illustrates a Hi/Low voltage output circuit according to a third embodiment; and

FIG. 8 is an overall perspective view of a liquid ejection head.

### DESCRIPTION OF THE EMBODIMENTS

Referring to the drawings, preferred embodiments of the present invention are exemplarily described in detail below. However, the dimensions, materials, shapes, and relative arrangements of components described in the embodiments are not intended to limit the scope of the present invention to only the ones unless otherwise described. In the following description, the materials and shapes of members described once are the same in the subsequent description as in the first description unless otherwise described again. For configurations and steps that are not particularly illustrated or described, well-known technologies or publicly known technologies in the technical field can be applied. Overlapping descriptions are sometimes omitted.

Hereinafter, a recording element substrate to be mounted to an inkjet recording head, an inkjet recording head, and a recording apparatus according to the present invention are described with reference to the drawings.

### First Embodiment

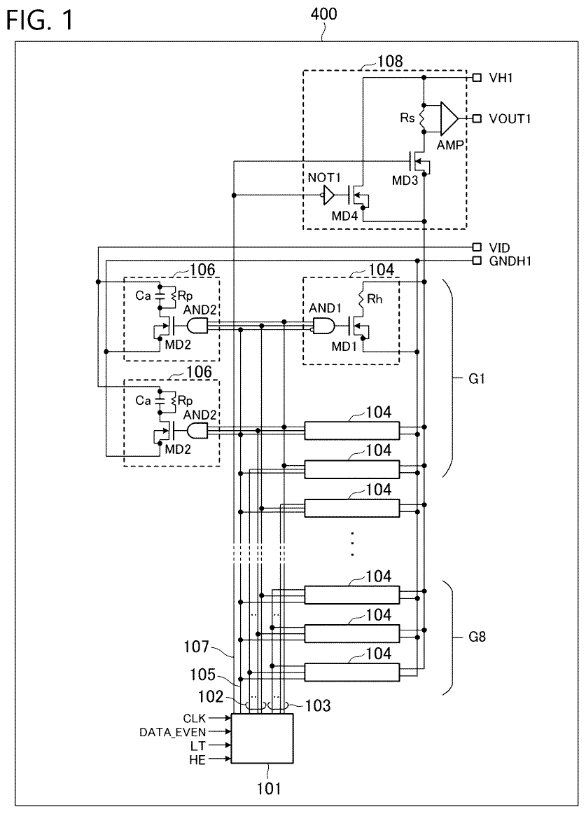

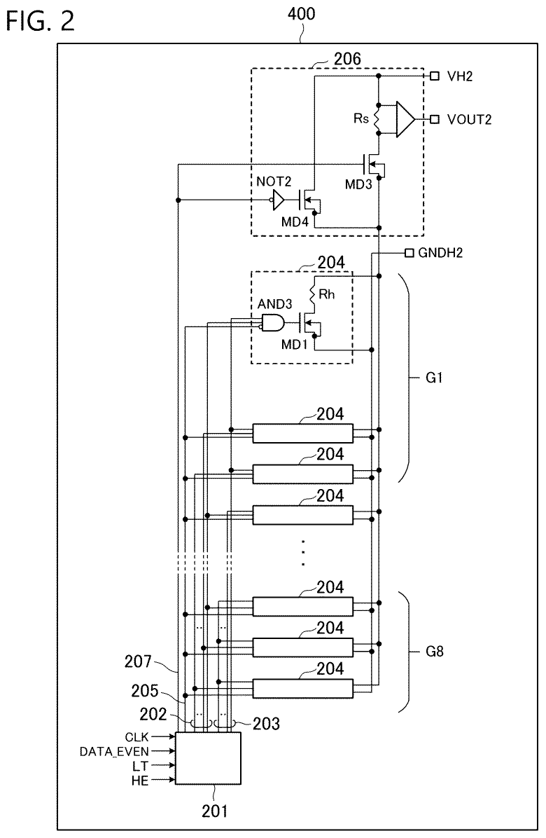

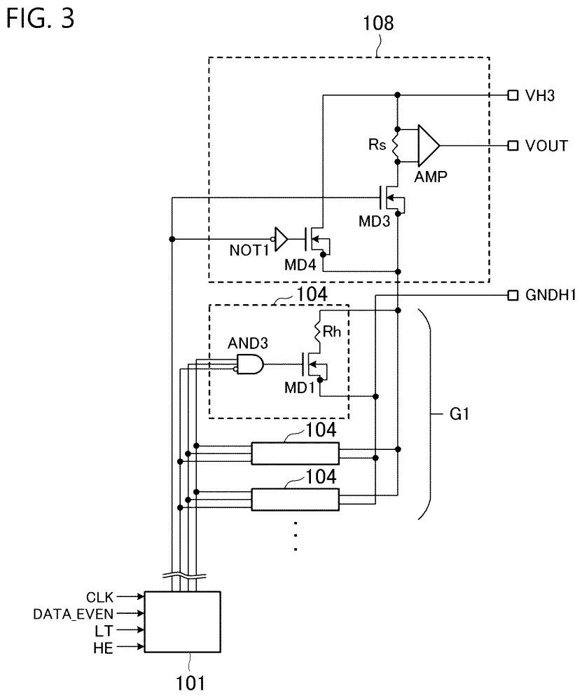

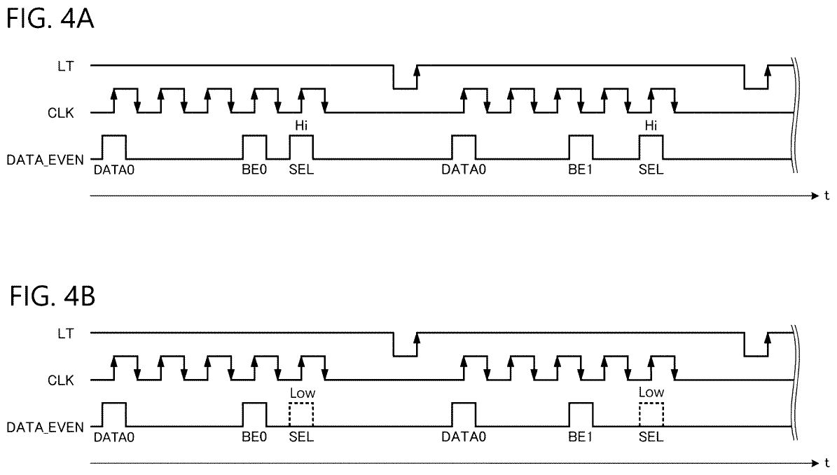

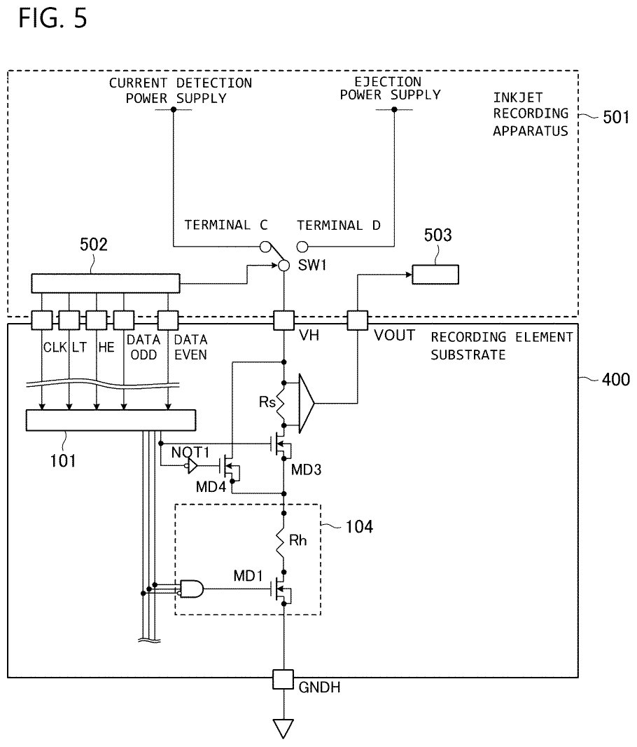

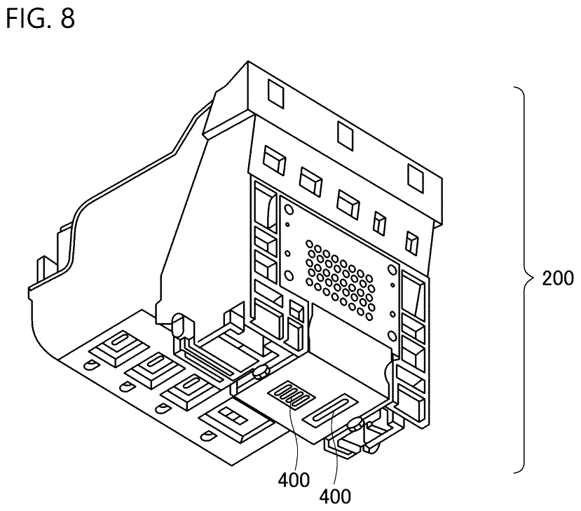

A first embodiment is described with reference to FIG. 1, FIG. 2, FIG. 3, FIG. 4A, FIG. 4B, FIG. 5, and FIG. 8. FIG. 8 is a perspective view illustrating a recording head 200 (liquid ejection head) according to the present embodiment. The recording head 200 is mounted on an inkjet type recording apparatus (liquid ejection apparatus), and forms an image by ejecting liquid such as ink to a recording medium such as paper.

In the recording head 200 in the present embodiment, two recording element substrates 400 for ejecting liquid are formed. The recording element substrate 400 has a heater (not shown) for heating ink. By energizing and heating the heater, air bubbles are generated in ink, and liquid is ejected from ejection ports in a plurality of rows. Note that the ejection ports are divided into even-numbered rows and odd-numbered rows, and control system circuits and power supply system circuits are also present separately.

### Circuit in Recording Element Substrate

A circuit formed in the recording element substrate is described with reference to FIG. 1 and FIG. 2. FIG. 1 and FIG. 2 illustrate circuit configurations of the recording element substrate 400 in the present embodiment.

FIG. 1 is an electric circuit diagram in which memory modules 106 and ejection modules 104 corresponding to ejection ports in even-numbered rows are formed in the recording element substrate 400, and a current detection circuit 108 is connected between the ejection modules 104 and a power supply voltage VH1. The recording element substrate 400 in the present embodiment has the plurality of ejection modules 104, the plurality of memory modules 106 (storage units), the current detection circuit 108, and a control data supply circuit 101 (control circuit). The plurality of ejection modules 104 correspond to a plurality of liquid chambers (containers) formed in the recording element substrate 400, respectively. The ejection module 104 heats liquid housed in a corresponding liquid chamber to generate air bubbles in the liquid, so that liquid is ejected from a nozzle (ejection port) provided on the side opposite to the side where the heat generating resistive element Rh is present in the liquid chamber.

The recording element substrate 400 is provided with a first voltage application terminal that is connected to the power supply voltage VH1 and forms a circuit for providing the current detection circuit 108 between the heat generating resistive element Rh and the power supply voltage VH1. The recording element substrate 400 is further provided with a second voltage application terminal that is connected to a power supply voltage VH3 and forms a circuit for preventing the current detection circuit 108 from being located between the heat generating resistive element Rh and the power supply voltage VH3 (an ejection circuit for applying voltage for ejection to the heat generating resistive element Rh). When any one of the current detection circuit and the ejection circuit is selected in accordance with a switch signal from a signal line 107, operations are switched between the state detection of the heat generating resistive element Rh and the ejection of liquid from the ejection module 104.

The ejection module 104 has a heat generating resistive element Rh for generating energy for ejecting liquid from ejection ports in even-numbered rows formed in the recording element substrate 400, a drive element MD1 for driving the heat generating resistive element Rh, and a logic circuit AND1. The drive element MD1 is a MOS transistor in the present embodiment. The MOS transistor has a role of a switch for determining whether to add voltage to the heat generating resistive element Rh. The logic circuit AND1 is an AND circuit for driving the drive element MD1 on the basis of signals from the control data supply circuit 101, and performs logical operations of a plurality of signals. When the drive element MD1 drives the heat generating resistive element Rh (that is, the heat generating resistive element Rh is energized to generate heat such that air bubbles are generated in ink), liquid can be ejected from ejection ports to enable recording. The heat generating resistive element Rh is supplied with the power supply voltage VH1 (for example, 24 V) through the current detection circuit 108. On the other hand, a ground voltage GNDH1 is supplied to the source side of the drive element MD1, which is a MOS transistor.

The memory module 106 has an anti-fuse element Ca, a parallel resistor Rp (resistive element) connected in parallel to the anti-fuse element Ca, a drive element MD2 for writing information in the anti-fuse element Ca, and a logic circuit AND2. The anti-fuse element Ca fixedly holds information by being supplied with overvoltage. In other words, the anti-fuse element Ca functions as an OTP (One Time Programmable) ROM, which is a memory that can be programmed only once. The anti-fuse element Ca is in an insulated state before overvoltage is supplied, and when overvoltage is supplied, the anti-fuse element Ca becomes a resistive element and enters an energized state. Thus, for example, 0 is determined when the anti-fuse element Ca is in the insulated state while 1 is determined when the anti-fuse element Ca is in the energized state, thus exhibiting a memory function.

The parallel resistor Rp is used to prevent overvoltage from a power supply voltage VID from being applied across the anti-fuse element Ca such that information is erroneously written in the anti-fuse element Ca although the drive element MD2 is in the non-conductive state. The drive element MD2 is, for example, a transistor. In the case of recording information of 1 in the anti-fuse element Ca, the drive element MD2 is driven to apply voltage to the anti-fuse element Ca, so that the anti-fuse element Ca becomes an energized state due to the applied voltage and information of 1 is stored.

The anti-fuse element Ca is supplied with the power supply voltage VID (for example, 24 V), and a ground voltage GNDH is supplied to the source side of the drive element MD2 that is a MOS transistor.

Note that the power supply voltage VID and the power supply voltage VH1 are independent power supply lines, but in the case where a minimum value of voltage required for writing in the anti-fuse element is equal to or less than the power supply voltage VH1, for example, the power supply voltage VH1 may be used together with a step-down circuit.

The current detection circuit 108 has a shunt resistor Rs that is a current detection resistor connected in series to the power supply voltage VH1, a voltage detector AMP, a drive element MD3 that functions as a switch for causing current to flow through the shunt resistor Rs, a drive element MD4 that is connected in series to the power supply voltage VH1 and the heat generating resistive element Rh and functions as a switch for causing current therethrough, and a logic circuit element NOT1.

The drive elements MD3 and MD4 in the present embodiment are MOS transistors. The drain side of MD3 is connected to the shunt resistor Rs, and the source side thereof is connected to the heat generating resistive element Rh. The drain side of MD4 is connected to the power supply voltage VH1, and the source side thereof is connected to the heat generating resistive element Rh. The logic circuit element NOT1 is a NOT circuit for driving the drive element MD4 on the basis of input of a switch signal through the signal line 107 from the control data supply circuit 101.

The switch signal from the signal line 107 is connected to both the drive element MD3 and the drive element MD4, and holds the state of 0 (Low) or 1 (Hi) such that only one of the drive element MD3 and the drive element MD4 becomes an ON state. The voltage detector AMP inputs potentials of both terminals of the shunt resistor Rs, and outputs a differential voltage value of the terminals of the shunt resistor Rs as VOUT1.

The control data supply circuit 101 is a circuit for driving the drive elements MD1, MD2, MD3, and MD4, and is configured by, for example, a shift register (not shown) or a latch circuit (not shown). A clock signal (CLK), a data signal (DATA), a latch signal (LT), and a heat enable signal (HE) from the outside of the recording element substrate are input to the control data supply circuit 101 through terminals of the recording element substrate. The data signal (DATA) includes information for selecting the ejection module 104, the memory module 106, and the drive elements MD3 and MD4. The data signal (DATA) is input in a serial form on the basis of the clock signal (CLK).

The control data supply circuit 101 receives the data signal (DATA), and generates a block selection signal, a group selection signal, an AND switch signal, and a NOT switch signal on the basis of information included in the data signal (DATA).

The ejection modules 104 in even-numbered rows, the memory module 106, and the drive elements MD3 and MD4 are selected and driven on the basis of the signals. The control data supply circuit 101 supplies the logic circuits (AND1 to AND2) with the block selection signal through a signal line 102, the group selection signal through a signal line 103, and the AND switch signal through a signal line 105. Furthermore, the control data supply circuit 101 supplies the NOT circuit (NOT1) with the NOT switch signal through a signal line 107.

To drive the ejection modules 104 and the memory modules 106 in a time-division manner, as illustrated in FIG. 1, the modules are divided into eight groups (G1, . . . , G8), each including three ejection modules 104. Furthermore, three blocks (1, 2, 3) are allocated to ejection modules 104 in each group. In this manner, the ejection modules 104 and the memory modules 106 can be selected and driven in a time-division manner.

The group selection signal is a signal for selecting which group is driven when a plurality of ejection modules 104 are divided into a plurality of groups. The block selection signal is a signal for selecting which of a plurality of heat generating resistive elements Rh in the same group is driven. For the drive element MD1, a DMOS transistor (Double-diffused MOSFET), which is a MOS transistor that can withstand high voltage, is used.

Note that, as an example, the plurality of ejection modules 104 are divided into eight groups (G1, . . . , G8) each including three ejection modules, but the present embodiment is not limited thereto. For example, the ejection modules 104 may be divided into eight groups each including 16 ejection modules.

The memory module 106 can drive the anti-fuse element Ca by using the signal line 102 and the signal line 103. In this case, the case where the anti-fuse element Ca is driven and the case where the ejection module 104 is driven are switched on the basis of the AND switch signal from the signal line 105.

To the memory module logic circuit AND2, the block selection signal, the group selection signal, and the switch signal from the signal line 105 are input. Then, when a signal corresponding to the input signals is input from the AND2 to the gate side of the memory module drive element MD2 such that the drive element MD2 is driven, current flows through the anti-fuse element Ca, and the anti-fuse element Ca is changed from an insulated state to an energized state. For the memory module drive element MD2, a DMOS transistor is used similarly to the ejection module drive element MD1.

FIG. 2 is an electric circuit diagram in which ejection modules 204 corresponding to ejection ports (not shown) in odd-numbered rows formed in the recording element substrate 400 are formed. The recording element substrate 400 in the present embodiment has a plurality of ejection modules 204, a control data supply circuit 201, and a current detection circuit 206. The ejection modules 204, the control data supply circuit 201, and the current detection circuit 206 have the same circuit configurations as those of the ejection modules 104 in even-numbered rows, the control data supply circuit 101, and the current detection circuit 108 described above, and control methods therefor are the same. Note that different circuits are used for even-numbered rows and odd-numbered rows in the present embodiment, but the method therefor is not limited thereto, and it is not always necessary to use different circuits.

### Current Detection Circuit

Referring to FIG. 3, detailed operation of the current detection circuit 108 in the case of detecting a current flowing through the heat generating resistive element Rh for the purpose of detecting deterioration of the heat generating resistive element Rh is described. FIG. 3 is a diagram mainly illustrating the current detection circuit 108 in FIG. 1, and the control data supply circuit 101, and one group of ejection modules 104 corresponding to ejection ports in even-numbered rows, and the current detection circuit 108 are extracted.

In the first embodiment, in the current detection circuit 108, 5 V is applied as a power supply voltage VH3 dedicated for current detection, and a ground voltage GNDH1 is connected. The voltage detector AMP is a differential amplifier for amplifying a minute differential voltage between two input terminals several tens of times, and outputting the resultant.

In the case of detecting the value of current flowing through the heat generating resistive element Rh, when the drive elements MD3 and MD1 are driven, the current flows from the power supply voltage VH3 to the ground voltage GNDH1 through the shunt resistor Rs, the drive element MD3, the heat generating resistive element Rh, and the drive element MD1. When VH3 is 5 V, the shunt resistor Rs is 5Ω, and a design resistance value of the heat generating resistive element Rh is 370Ω, the flowing current value is 13.3 mA according to Ohm's law. In this case, the potential difference at each end of the shunt resistor is 0.07 V. When the voltage amplification factor of the differential amplifier is 20, the output voltage VOUT1 is 1.40 V. In this manner, in the case of detecting deterioration of the heat generating resistive element Rh, the voltage amplification factor and the values of the shunt resistor Rs are known design values, and hence if the output voltage VOUT1 can be detected, the current value flowing through the heat generating resistive element Rh and the resistance value thereof can be calculated by Ohm's law. Note that a calculation unit for performing such calculation processing is not limited as long as the calculation unit is a circuit having an arithmetic function. In the present embodiment, a determination unit 503 included in a recording apparatus 501 is used as the calculation unit, but an arithmetic circuit may be provided in a recording head.

On the other hand, in the case where current detection operation is performed after the recording head 200 is used for a given period of time, VH3 is 5 V, the shunt resistor Rs is 5Ω, and the differential voltage at each end of the shunt resistor is 0.025 V, which means that the output voltage of the voltage detector AMP is 0.50 V due to the multiplication of 20. Thus, the current flowing through the heat generating resistive element Rh is 5.00 mA, and the resistance value can be calculated to 1,000Ω.

In this manner, by comparing the resistance value 370Ω (detected current: 13.3 mA) of the heat generating resistive element Rh before the recording head 200 is used with the resistance value 1,000Ω (detected current: 5.00 mA) of the deteriorated heat generating resistive element Rh, the degree of deterioration of the heat generating resistive element Rh can be detected. Thus, the use application of the recording head 200 can be classified to reusing or recycling.

Note that the resistance value of the shunt resistor Rs and the amplification factor of the differential amplifier need to be designed as appropriate in consideration of change amounts of the resistance value of the mounted heat generating resistive element Rh and the output voltage VOUT1.

FIG. 4A illustrates waveforms of signals input to the control data supply circuit 101 when two heat generating resistive elements Rh are sequentially driven one by one and current detection operation is performed in the first embodiment.

The input signals include LT, CLK, and DATA_EVEN. DATA_EVEN includes block selection for even-numbered rows, group selection, and NOT circuit switch signal information. DATA_EVEN is a signal that becomes a Hi state at the rising of CLK and becomes a Low state at the falling of CLK. When the contents of the signal are DATA0 and BE0, drive elements MD in a group 1 and a block 1 are selected. Next, when the contents of the signal are DATA0 and BE1, drive elements MD in a group 1 and a block 2 are selected. In FIG. 4A, SEL is in the Hi state, and hence the drive element MD3 is ON and the drive element MD4 is OFF.

On the other hand, FIG. 4B illustrates waveforms of signals input to the control data supply circuit 101 when ejection operation is performed. FIG. 4B is different from FIG. 4A in that SEL is in the Low state and hence the drive element MD3 is OFF and the drive element MD4 is ON.

Referring to FIG. 4A and FIG. 4B, the signals for sequentially driving the two heat generating resistive elements Rh have been described. However, in the first embodiment, the DATA_EVEN signal can sequentially drive 24 heat generating resistive elements Rh in total connected to groups 1 to 8 and blocks 0 to 2. That is, by combining signals of DATA 0 to 7 and BE 0 to 2, and sequentially inputting DATA_EVEN signals in which SEL is in the Hi state so that the heat generating resistive elements Rh are sequentially driven, the currents flowing through all the heat generating resistive elements can be detected to determine the deterioration state.

FIG. 5 is a diagram illustrating a circuit configuration of the recording element substrate 400 and an inkjet type recording apparatus 501 in the present embodiment. The recording apparatus 501 includes a control unit 502 and a determination unit 503. The control unit 502 controls operation of the recording element substrate 400. The determination unit 503 is a circuit for comparing a voltage VOUT, which is output when the current of the heat generating resistive element Rh is detected, with a voltage recorded in advance to calculate and determine the state (for example, degree of deterioration) of the heat generating resistive element Rh. The control unit 502 and the determination unit 503 can be implemented by, for example, an information processing circuit or a control circuit provided with arithmetic resources such as a processor and a memory.

Furthermore, the control unit 502 controls the switching of SW1. When SW1 is connected to a terminal C, a path between a current detection power source (for example, 5 V) and the heat generating resistive element Rh is established. When SW1 is connected to a terminal D, a path between an ejection power source (for example, 24 V) and the heat generating resistive element Rh is established.

Furthermore, the control unit 502 generates control data to be transmitted to the internal control data supply circuit 101 through the CLK terminal, the LT terminal, the HE terminal, the DATAODD terminal, and the DATA_EVEN terminal of the recording element substrate 400. The control data includes a clock signal (CLK), a latch signal (LT), a heat enable signal (HE), and data signals (DATA_ODD, DATA_EVEN). The control data is used to control driving of the drive elements MD1, MD3, and MD4.

The data signal DATAEVEN controls an ejection module and a current detection circuit that correspond to ejection ports in even-numbered rows formed in the recording element substrate 400, and the data signal DATAODD controls an ejection module and a current detection circuit that correspond to ejection ports in odd-numbered rows. The clock signal, the latch signal, and the heat enable signal are common to even-numbered rows and odd-numbered rows.

As described above, in the conventional method using indirect electrostatic induction in the state detection of the heat generating resistive element Rh provided in the recording element substrate 400 used for the recording head 200, a large change in current value flowing through the heat generating resistive element wiring can be grasped, but detailed measurement of the current value cannot be performed. Accordingly, although the presence/absence of disconnection of the heat generating resistive element wiring can be detected, it is difficult to detect detailed deterioration states caused by change in resistance value of the heat generating resistive element Rh.

In the present invention, on the other hand, the detection circuit is connected in series to the heat generating resistive element wiring by wiring to measure the value of current flowing through the heat generating resistive element wiring. For example, a circuit capable of measuring all values of currents each flowing through each heat generating resistive element Rh can be provided inside the recording element substrate 400. Furthermore, the current detection circuit 108 that connects the heat generating resistive element wiring in series to the current detection shunt resistor Rs by wiring can be formed such that the value of current flowing through the heat generating resistive element can be calculated from the voltage value at each end of the shunt resistor and the shunt resistance value. Accordingly, the value of current flowing through each heat generating resistive element Rh can be measured from the calculated current value, and hence not only the disconnected state of the heat generating resistive element Rh but also the detailed deterioration state can be detected.

### Second Embodiment

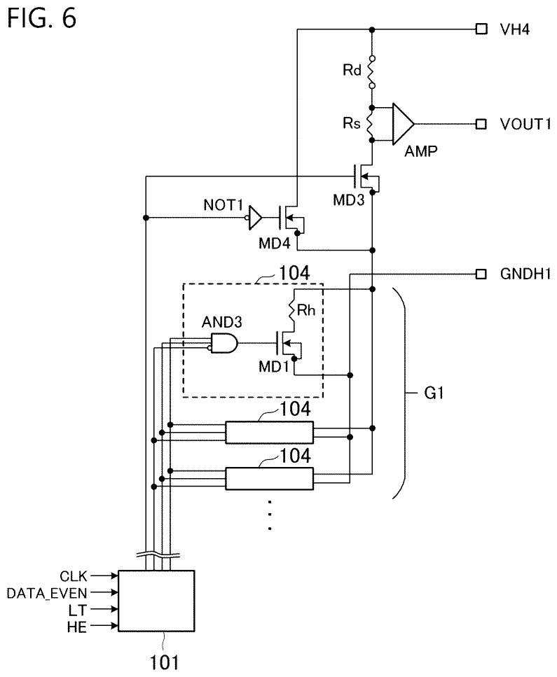

A second embodiment is described with reference to FIG. 6. Note that descriptions of the same configurations and operations as in the first embodiment are omitted. In FIG. 6, a step-down resistor Rd is inserted between a power supply voltage VH4 (VH3 in the first embodiment) and the shunt resistor Rs. The step-down resistor Rd functions to decrease a voltage value applied to the power supply voltage VH4, and has a purpose of applying a decreased voltage to the heat generating resistive element Rh during the operation of current detection of the heat generating resistive element Rh.

In the present embodiment, the current detection operation is performed similarly to the first embodiment, but the present embodiment is preferred for the case where a high voltage power supply common to an ejection power supply is used without using a power supply dedicated for current detection as the power supply voltage VH4. The current detection operation may be executed while there is no ink in the recording head 200, and is driving without the ejection of ink. Thus, there is a risk in that breakdown of elements around the heat generating resistive element Rh may be caused due to idle ejection and long-term high voltage application. Thus, in the present embodiment, a voltage obtained by decreasing the power supply voltage VH4, which is high voltage, by the step-down resistor Rd is applied to the heat generating resistive element Rh.

For example, the step-down resistor Rd is 5 kΩ, the power supply voltage VH4 is 24 V, the shunt resistor Rs is 5Ω, and a design resistance value of the heat generating resistive element Rh is 370Ω. In this case, a flowing current value is 4.43 mA according to Ohm's law, and the value of voltage applied to an upstream terminal of the shunt resistor Rs is reduced to be as low as 1.85 V.

In this manner, by inserting the step-down resistor Rd, the application voltage of the power supply voltage VH4 for ink ejection and the application voltage of the power supply voltage VH4 for current detection operation can be the same. As a result, a low voltage value dedicated for current value detection is not required to be input from the outside of a head, and hence a dedicated power supply on the inkjet recording apparatus side is unnecessary, and design loads and apparatus cost can be reduced.

### Third Embodiment

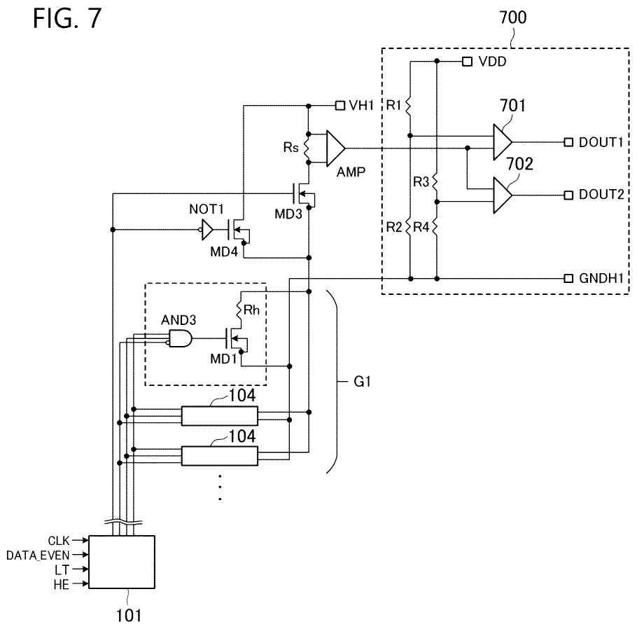

A third embodiment is described with reference to FIG. 7. Note that descriptions of the same configurations and operations as in the first and second embodiments are omitted. FIG. 7 is a circuit diagram in which a comparator circuit 700 is connected to an output terminal of a voltage detector AMP. This circuit is a circuit for converting an analog voltage output from the voltage detector AMP into Hi voltage and Low voltage at terminals DOUT1 and DOUT2 on the basis of a reference voltage.

The comparator circuit 700 in the present embodiment includes two comparators 701 and 702. One input terminal of the comparator 701 is connected to the output of the voltage detector AMP, and the other input terminal is connected between reference voltage generating resistors R1 and R2. Similarly, one terminal of the comparator 702 is connected to the output of the voltage detector AMP, and the other terminal is connected between reference voltage generating resistors R3 and R4.

The comparator 701 uses a divided voltage value of a voltage VDD between R1 and R2 with reference to GNDH1 as a reference voltage, and compares the reference voltage with the output voltage of the voltage detector AMP. When the value of the output voltage is larger, DOUT1 becomes Hi, and on the other hand, when the value of the output voltage is smaller, DOUT1 becomes Low. The comparator 702 performs similar operation. When the value of the output voltage is larger than a reference voltage, DOUT2 becomes Hi, and on the other hand, when the value of the output voltage is smaller, DOUT2 becomes Low. In this case, when two kinds of different values are used for the reference voltages input to the comparators 701 and 702, the output voltage value of the voltage detector AMP can be classified into 2-bit information (four kinds). This circuit has an effect of simplifying a voltage reading circuit by converting the output voltage of the voltage detector AMP into Hi voltage and Low voltage.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-195108, filed on Nov. 16, 2023, which is hereby incorporated by reference wherein in its entirety.

What is claimed is:

1. A recording element substrate, comprising:
an ejection module including a heat generating resistive element;
a current detection circuit including a current detection resistor connected in series between the heat generating resistive element and a voltage application terminal for applying voltage from a power supply to the heat generating resistive element, and a voltage detector configured to detect a differential voltage at each end of the current detection resistor;
an ejection circuit provided between the voltage application terminal and the heat generating resistive element, and configured to apply voltage for causing the heat generating resistive element to generate heat from the voltage application terminal to the heat generating resistive element; and
a control circuit configured to select any one of the current detection circuit and the ejection circuit.

2. The recording element substrate according to claim 1, wherein, in a case of applying voltage to the heat generating resistive element through the current detection circuit, the heat generating resistive element is applied with voltage that is lower than voltage applied to the heat generating resistive element through the ejection circuit.

3. The recording element substrate according to claim 1, wherein a step-down resistor configured to step down voltage applied to the current detection resistor is provided between the voltage application terminal and the current detection resistor.

4. The recording element substrate according to claim 1, wherein the current detection resistor provided in the current detection circuit is a shunt resistor.

5. The recording element substrate according to claim 4, wherein the voltage detector provided in the current detection circuit is a differential amplifier configured to amplify and output the differential voltage at each end of the current detection resistor.

6. The recording element substrate according to claim 1, wherein the current detection circuit further comprises a circuit configured to compare output of the voltage detector with a reference voltage and classify a resultant thereof.

7. The recording element substrate according to claim 1, wherein the control circuit is configured to select the ejection circuit to cause the heat generating resistive element to generate heat such that liquid housed in a liquid chamber corresponding to the ejection module is heated and ejected from an ejection port.

8. A recording apparatus, comprising:
a recording element substrate; and
a determination unit,
wherein the recording element substrate includes:
an ejection module including a heat generating resistive element;
a current detection circuit including a current detection resistor connected in series between the heat generating resistive element and a voltage application terminal for applying voltage from a power supply to the heat generating resistive element, and a voltage detector configured to detect a differential voltage at each end of the current detection resistor;
an ejection circuit provided between the voltage application terminal and the heat generating resistive element, and configured to apply voltage for causing the heat generating resistive element to generate heat from the voltage application terminal to the heat generating resistive element; and
a control circuit configured to select any one of the current detection circuit and the ejection circuit, and
wherein the determination unit is configured to determine a state of the heat generating resistive element on the basis of output from the current detection circuit.

9. The recording apparatus according to claim 8, wherein the determination unit is configured to calculate a current value flowing through the heat generating resistive element on the basis of the differential voltage output from the voltage detector in the current detection circuit, and determine a degree of deterioration of the heat generating resistive element on the basis of the current value.

10. The recording apparatus according to claim 8, wherein the determination unit is configured to calculate a resistance value of the heat generating resistive element on the basis of the differential voltage output from the voltage detector in the current detection circuit, and determine a degree of deterioration of the heat generating resistive element on the basis of the resistance value.

11. The recording apparatus according to claim 9, wherein:
the recording element substrate is provided to the recording apparatus while mounted to a recording head; and
the determination unit is configured to determine whether to reuse or recycle the recording head on the basis of the degree of deterioration of the heat generating resistive element.
